(19) United States
(12) Patent Application Publication
(10) Pub. No.: US 2014/0186549 A1
(43) Pub. Date: Jul. 3, 2014

(54) POWDER SUPPLY NOZZLE AND OVERLAYING METHOD

(71) Applicants: Masanori Miyagi, Tokyo (JP); Takeshi Tsukamoto, Tokyo (JP); Hirotugu Kawanaka, Tokyo (JP); Kenichi Okamoto, Tokyo (JP)

(72) Inventors: Masanori Miyagi, Tokyo (JP); Takeshi Tsukamoto, Tokyo (JP); Hirotugu Kawanaka, Tokyo (JP); Kenichi Okamoto, Tokyo (JP)

(73) Assignee: HITACHI, LTD., Tokyo (JP)

(21) Appl. No.: 14/239,979

(22) PCT Filed: Aug. 9, 2012
(86) PCT No.: PCT/JP2012/070303

§ 371 Date: Feb. 20, 2014

(30) Foreign Application Priority Data
Sep. 30, 2011 (JP) 2011-215897

(51) Int. Cl. C23C 4/12; B05B 1/24

(52) U.S. Cl. CPC C23C 4/121; B05B 1/24
USPC 427/554; 239/133

(57) ABSTRACT

An object of the present invention is to provide a powder supply nozzle and an overlaying method which make it possible to restrain oxidation of a clad layer part and to produce a clad layer part with high quality. The invention provides a powder supply nozzle including: a laser emission part for irradiating a workpiece with a laser beam; and a powder supply part disposed in the periphery of the laser emission part and adapted to discharge a powder onto a laser-irradiated part, wherein a mechanism for guiding the air surrounding the laser-irradiated part to the exterior of the laser-irradiated part is provided in the periphery of the powder supply part.

### TECHNICAL FIELD

The present invention relates to a powder supply nozzle and an overlaying method which are for use in laser cladding with a powder as a filler material.

### BACKGROUND ART

In recent years, laser cladding in which a powder is used as a filler material has been used, for example, as a surface treatment technology aimed at direct shaping of the near net shape type or at imparting a function such as wear resistance. In order to form a clad layer of high quality in the laser cladding, it is necessary to blow a shield gas into the working area so as to restrain oxidation of the clad layer part. In the case of laser cladding in which a powder is used, the flow rate of a carrier gas for transporting the powder may be increased to enhance the powder flow velocity, in order to stably supply the powder into the working area. When the powder flow velocity is raised; however, the air surrounding the powder flow would be entrained, so that the air may flow into, the working area, resulting in poor shield properties. To cope with such a problem, a powder supply nozzle having a shield gas supply nozzle provided in the periphery thereof so as to enhance shield properties has been devised, as described in Patent Document 1.

### PRIOR ART DOCUMENT

### Patent Document

Patent Document Published Japanese Translation of PCT International Application (Kohyo) No 1998-501463

### SUMMARY OF THE INVENTION

### Problem to be Solved by the Invention

The powdered metal cladding nozzle based on the use of a laser beam as above-mentioned is an invention which allows a shield gas to flow in the periphery of the powder, thereby enhancing the shield properties. In this case, a configuration is adopted in which the powder is supplied together with a carrier gas into the working area from the periphery of the laser beam. Specifically, a shield gas nozzle for blowing a shield gas toward the working area is provided in the periphery of a powder supply part. Thus, in the invention, the shield gas is made to flow in the surroundings of the powder, thereby preventing oxidation of the clad layer part. The cladding nozzle, however, has a problem that an increase in the shield gas flow velocity causes entrainment of the surrounding air, so that it is hard to restrain oxidation of the clad layer part.

In view of the foregoing, it is an object of the present invention to provide a powder supply nozzle and an overlaying method which make it possible to restrain oxidation of a clad layer part and to produce a high-quality clad layer part.

### Means for Solving the Problem

A powder supply nozzle includes: a laser emission part which has a tubular innermost nozzle having a center axis coincident with a laser optic axis and connected to a laser beam condensing part and a gas supply source, the laser emission part radiating a laser beam while blowing off an inert gas, the radiating and blowing-off being performed from a tip of the innermost nozzle onto a workpiece; and a powder supply part which has a tubular inner nozzle disposed in the periphery of the laser emission part and having a center axis coincident with the laser optic axis, the inner nozzle connected to a powder supply source, the space defined by the inner nozzle and the laser emission part being used as a powder passage, the powder supply part discharging a powder together with a carrier gas from the inner nozzle to a laser-irradiated part, wherein: the powder supply nozzle includes a tubular outer nozzle disposed in the periphery of the powder supply part and having a center axis coincident with the laser optic axis; the outer nozzle is connected to suction equipment or the gas supply source; and the space defined by the inner nozzle and the outer nozzle is used as a suction passage or a gas supply passage.

### Effect of the Invention

According to the present invention, there is obtained an advantage that, first, it is possible to restrain oxidation of a clad layer part and it is also possible to produce a clad layer part with high quality.

### BRIEF DESCRIPTION OF THE DRAWINGS

FIG. 1 is a sectional view of a powder supply nozzle in a first embodiment of the present invention.

FIG. 2 is a schematic view of the vicinity of a clad layer part in the first embodiment.

FIG. 3 is a layout view of powder and gas introduction parts of the powder supply nozzle in the first embodiment.

FIG. 4 is a sectional view of a powder supply nozzle in a second embodiment of the present invention.

FIG. 5 is a schematic view of the vicinity of a clad layer part in the second embodiment.

FIG. 6 is a layout view of powder and gas introduction parts of the powder supply nozzle in the second embodiment.

### MODE FOR CARRYING OUT THE INVENTION

As a first mode, the object to prevent oxidation of a clad layer part in laser cladding conducted using a powder as a filler material has been attained by a powder supply nozzle according to the present mode. The powder supply nozzle includes a laser emission part and a powder supply part. The laser emission part has a tubular innermost nozzle having a center axis coincident with the laser optic axis. The innermost nozzle is connected to a laser beam condensing part and a gas supply source. A laser beam is radiated and an inert gas is blown off, from the tip of the innermost nozzle onto a workpiece. The powder supply part has a tubular inner nozzle disposed in the periphery (on the outer circumference side) of the laser emission part and having a center axis coincident with the laser optic axis. The inner nozzle is connected to the powder supply source. A space defined by the inner nozzle and the laser emission part is used as a powder passage, through which a powder is discharged toward the laser-irradiated part together with a carrier gas.

The powder supply nozzle, further, has a tubular outer nozzle disposed in the periphery of the powder supply part and having a center axis coincident with the laser optic axis. The outer nozzle is connected to the gas supply source, and a space defined by the inner nozzle and the outer nozzle is used as a gas supply passage. The blow-off angle at the tip of the outer nozzle is within the range from 0° to 60° in a direction for spreading toward the outside of the nozzle relative to the laser optic axis. In addition, the outer nozzle is provided with a plurality of gas blow-off ports, and a mechanism is provided by which the flow rate of the gas supplied through each of the gas blow-off ports is controlled by use of an external signal.

As a second mode, the object to prevent oxidation of a clad layer part in laser cladding conducted using a powder as a filler material has been attained by another powder supply nozzle according to the present mode. The another powder supply nozzle includes a laser emission part and a powder supply part. The laser emission part has a tubular innermost nozzle having a center axis coincident with the laser optic axis. The innermost nozzle is connected to the laser beam condensing part and the gas supply source. A laser beam is radiated and an inert gas is blown off, from the tip of the innermost nozzle onto the workpiece. The powder supply part has a tubular inner nozzle disposed in the periphery of the laser emission part and having a center axis coincident with the laser optic axis. The inner nozzle is connected to the powder supply source. A space defined by the inner nozzle and the laser emission part is used as a powder passage, through which the powder is discharged toward the laser-irradiated part together with a carrier gas.

The another powder supply, nozzle, further, has a tubular outer nozzle disposed in the periphery of the powder supply part and having a center axis coincident with the laser optic axis. The outer nozzle is connected to suction equipment, and the outer nozzle is provided with a plurality of suction ports. A mechanism is provided by which the flow rate of a gas sucked through each of the suction ports is controlled by use of an external signal.

### Embodiment 1

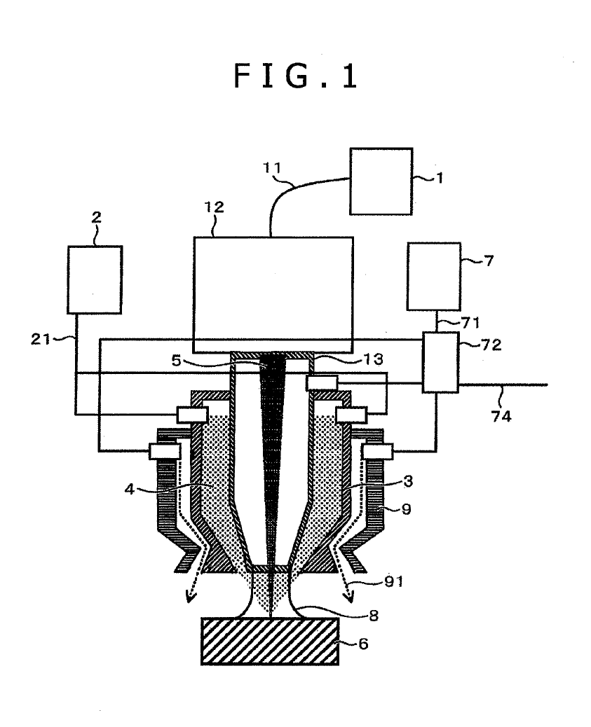

FIG. 1 shows a sectional view of a powder supply nozzle according to Embodiment 1.

Numeral 1 denotes a laser oscillator, 11 an optical fiber, 12 a laser beam condensing part, 13 a laser emission part, 2 a powder supply device, 21 a powder feeding passage, 3 an inner nozzle, 4 a powder flow, 5 a laser beam, 6 a workpiece, 7 a gas supply source, 71 a gas supply pipe, 72 a gas supply quantity control mechanism, 74 a gas supply quantity control signal wire, 8 a shield gas flow, 9 an outer nozzle, and numeral 91 denotes a guide gas. The laser beam 5 generated in the laser oscillator 1 is transmitted through the optical fiber 11 to the laser beam condensing part 12. The laser beam 5 condensed by the laser beam condensing part 12 is radiated through the laser emission part 13 onto the workpiece 6. The inner nozzle 3, was provided in the periphery (on the outer circumference side) of the laser emission part 13, and the space defined between the laser emission part 13 and the inner nozzle 3 was used as a powder passage. A powder fed from the powder supply device 2 together with a carrier gas is sent through the powder feeding passage 21 into the inner nozzle, to be blown from the inner nozzle toward the working area. The laser emission part 13 is connected to the gas supply source 7, and the shield gas flow 8 can be blown to the working area through the gas supply pipe 71 and the laser emission part 13. The outer nozzle 9 was provided in the periphery of the inner nozzle 3, and the space defined between the inner nozzle 3 and the outer nozzle 9 is used as a gas passage. The outer nozzle 9 was connected to the gas supply source 7, and the gas can be discharged through the gas supply pipe 71 and the outer nozzle 9. A discharge port of the outer nozzle 9 is directed toward the outside of the working area, and the guide gas 91 discharged through the outer nozzle 9 is discharged toward the outside of the shield gas flow 8.

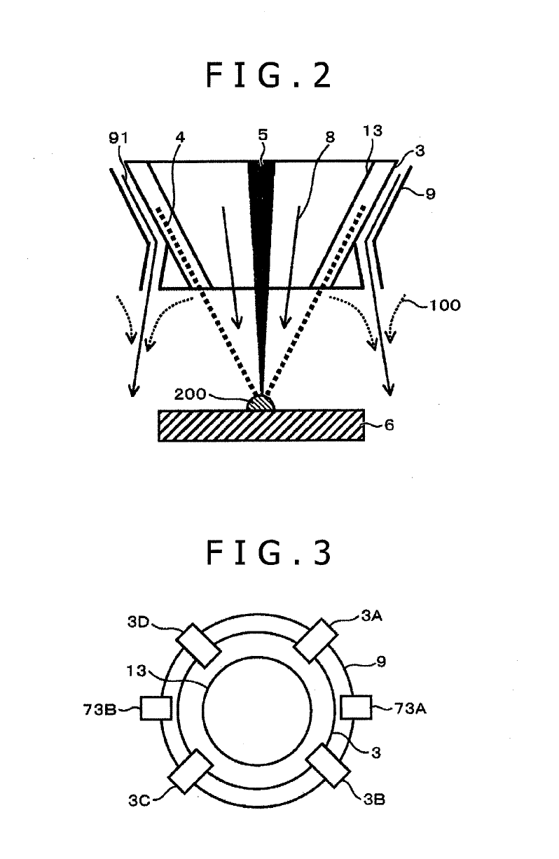

FIG. 2 shows a schematic view of the vicinity of the working area. Numeral 100 denotes the air, and 200 denotes the clad layer part. The powder flow 4 is melted by the laser beam 5 radiated toward the workpiece 6, and the clad layer part 200 is formed thereby. In this instance, the shield gas flow 8 was blown off from the laser emission part 13 toward the working area. In the case where the flow velocity of the powder flow 4 is high, however, the surrounding air 100 may be entrained into the powder flow 4, whereby the clad layer part 200 may be oxidized, resulting in a lowered quality.

Blow-off ports of the outer nozzle 9 disposed in the periphery of the inner nozzle 3 are directed toward the outside of the clad layer part. In this embodiment, the blow-off ports are inclined at about 15° toward the outside relative to the laser optic axis. The working (cladding) was conducted while blowing the guide gas 91 from the outer nozzle 9 at a flow velocity higher than the flow velocity of the powder flow 4. With the flow velocity of the guide gas 91 set higher than the flow velocity of the powder flow 4, the air 100 present in the surroundings of the working area is preferentially entrained into the guide gas 91. Therefore, the air is guided to the outside of the clad layer part, and oxidation of the clad layer part 200 is restrained.

FIG. 3 shows a layout view of powder and gas introduction parts of the present nozzle. Signs 3A, 3B, 3C and 3D denote the powder introduction parts, and signs 73A and 73B denote the gas introduction parts. The gas introduction parts 73A, 73B are connected to the gas supply quantity control mechanism 72 through the gas supply pipe. 71, and the flow rates of the gas sent to the gas introduction parts 73A, 73B can be controlled arbitrarily, whereby the flow rate distribution of the gas discharged from the outer nozzle 9 can be controlled. The flows of fluids in the surroundings of the working area may vary depending on the shape of the workpiece. Therefore, by controlling the flow rate distribution of the gas discharged from the outer nozzle 9 according to the shape of the workpiece, a stable shield effect can be obtained irrespectively of changes in the shape of the workpiece, and a clad layer part of high quality can be formed.

While the angle of the outer nozzle was inclined at about 15° toward the outside relative to the laser optic axis in the present embodiment, the inclination angle is preferably set in the range from to 60°, more preferably from 0° to 30°. In addition, while four powder introduction parts and two gas introduction parts were provided in the present embodiment, this configuration is not restrictive of the present invention.

### Embodiment 2

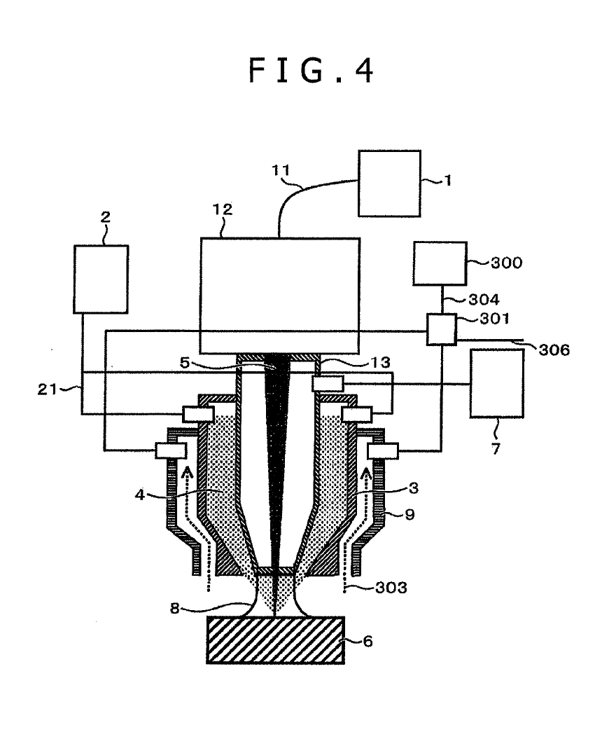

FIG. 4 shows a sectional view of a powder supply nozzle according to Embodiment 2. Numeral 1 denotes a laser oscillator, 11 an optical fiber, 12 a laser beam condensing part, 13 a laser emission part, 2 a powder supply device, 21 is a powder feeding passage, 3 an inner nozzle, 4 a powder flow, 5 a laser beam, 6 a workpiece, 7 a gas supply source, 8 a shield gas flow, 9 an outer nozzle, 300 a rotary pump, 301 a suction flow rate control mechanism, 303 a sucked fluid, 304 a suction piping, and numeral 306 denotes a suction flow rate control signal.

The laser beam 5 generated in the laser oscillator 1 is transmitted through the optical fiber 11 to the laser beam condensing part 12. The laser beam 5 condensed by the laser beam condensing part 12 is radiated through the laser emission part 13 onto the workpiece 6. The inner nozzle 3 was provided in the periphery of the laser emission part 13, and the space defined between the laser emission part 13 and the inner nozzle 3 was used as a powder passage. A powder fed from the powder supply device 2 is sent through the powder feeding passage 21, into the inner nozzle, to be blown off from the inner nozzle, toward the working area. The laser emission part 13 is connected to the gas supply source 7, and the shield gas flow 8 can be blown to the working area through the gas supply pipe 71 and the laser emission part 13. The outer nozzle 9 was provided in the periphery of the inner nozzle 3, and the space defined between the inner nozzle 3 and the outer nozzle 9 was used as a suction passage. The outer nozzle 9 is connected to the rotary pump 300, and a fluid or fluids in the surrounding of the working area can be sucked through the suction pipe 304 and the outer nozzle 9.

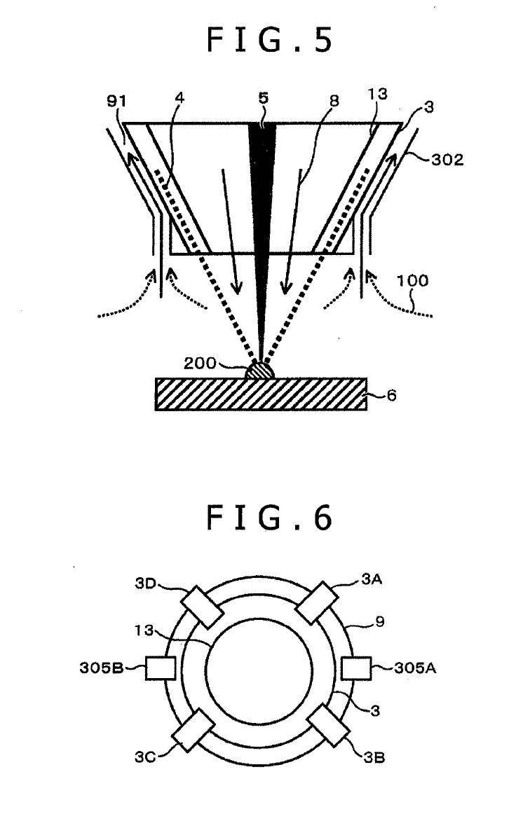

FIG. 5 shows a schematic view of the vicinity of the working area. The powder flow 4 is melted by the laser beam 5 radiated toward the workpiece 6, and a clad layer part 200 is formed thereby. In this instance, the shield gas flow 8 was blown off from the laser emission part 13 toward the working area. In the case where the flow velocity of the powder flow is high, however, the surrounding air 100 may be entrained into the powder flow 4, whereby the clad layer part 200 may be oxidized, resulting in a lowered quality.

The outer nozzle 9 was disposed in the periphery of the inner nozzle 3. The suction port of the outer nozzle 9 is directed downward, in parallel to the laser optic axis. The working (cladding) was conducted while sucking the fluid or fluids surrounding the working area, mainly the air, through the outer nozzle 9. With the air (which would otherwise be entrained into the powder flow) sucked in through the suction nozzle, mixing of the air into the clad layer part 200 is restrained, and a clad layer part 200 with high quality is formed.

FIG. 6 shows a layout view of the powder and suction parts in the powder supply nozzle according to the present embodiment. Signs 305A, 305B denote the suction parts. The suction parts 305A, 305B are connected to the suction flow rate control mechanism 301, so that the flow rates in suction through the suction parts 305A, 305B can be controlled arbitrarily, and the flow rate distribution of the fluid sucked in through the outer nozzle 9 can be controlled. The flows of the fluids surrounding the working area may vary depending on the shape of the workpiece. Therefore, by controlling the flow rate distribution of the fluid or fluids sucked in through the outer nozzle 9 according to the shape of the workpiece, stable shield effect can be obtained irrespectively of changes in the shape of the workpiece, and a clad layer part with high quality can be obtained.

While the angle of, the suction nozzle was set to be downward in parallel to the laser-optic axis in this embodiment, the inclination angle is preferably in the range from 0° to 60°, more preferably from 0° to 30°.

In addition, while four powder introduction parts and two gas introduction parts were provided in the present embodiment, this configuration is not restrictive of the present invention.

Besides, while the rotary pump was used as the suction mechanism in this embodiment, this configuration is not restrictive of the present invention.

### EXPLANATION OF REFERENCE SIGNS

1 Laser Oscillator
2 Powder supply device
3 Inner nozzle,
3A, 3B, 3C, 3D Powder introduction part
4 Powder flow
5 Laser beam
6 Workpiece
7 Gas supply source
8 Shield gas flow
9 Outer nozzle
11 Optical fiber
12 Laser beam condensing part
13 Laser emission part
21 Powder feeding passage
71 Gas supply pipe
72 Gas supply quantity control mechanism
73A, 73B Gas introduction part
74 Gas supply quantity control signal wire
91 Guide gas
100 Air
200 Clad layer part
300 Rotary pump
301 Suction flow rate control mechanism
303. Sucked fluid
304 Suction piping
305A, 305B Suction part
306 Suction flow rate control signal wire

1. A powder supply nozzle comprising:
a laser emission part which has a tubular innermost nozzle having a center axis coincident with a laser optic axis and connected to a laser beam condensing part and a gas supply source, the laser emission part radiating a laser beam while blowing off an inert gas, the radiating and blowing-off being performed from a tip of the innermost nozzle onto a workpiece; and
a powder supply part which has a tubular inner nozzle disposed in the periphery of the laser emission part and having a center axis coincident with the laser optic axis, the inner nozzle connected to a powder supply source, the space defined by the inner nozzle and the laser emission part being used as a powder passage, the powder supply part discharging a powder together with a carrier gas from the inner nozzle to a laser-irradiated part, wherein:
the powder supply nozzle includes a tubular outer nozzle disposed in the periphery of the powder supply part and having a center axis coincident with the laser optic axis;
the outer nozzle is connected to the gas supply source;
the space defined by the inner nozzle and the outer nozzle is used as a gas supply passage; and
a blow-off angle at a tip of the outer nozzle is within the range from 0°, exclusive, to 60°, inclusive, in a direction for spreading toward the outside of the nozzle relative to the laser optic axis.

2. The powder supply nozzle according to claim 1, wherein:
the outer nozzle is provided with a plurality of gas blow-off ports; and
a mechanism is provided for controlling the flow rate of a guide gas supplied through each of the gas blow-off ports by use of an external signal.

3. The powder supply nozzle according to claim 1, wherein:
the outer nozzle is connected to suction equipment;
the outer nozzle is provided with a plurality of suction ports; and
a mechanism is provided for controlling the flow rate of a gas sucked through each of the suction ports by use of an external signal.

4. The powder supply nozzle according to claim 1, wherein:
the powder supply nozzle is provided with a tubular outermost nozzle disposed in the periphery of the outer nozzle and connected to suction equipment; and
the space defined by the outer nozzle and the outermost nozzle is used as a suction passage.

5. The powder supply nozzle according to claim 1, wherein:
a tubular outermost nozzle is disposed in the periphery of the outer nozzle and connected to suction equipment;
the space defined by the outer nozzle and the outermost nozzle is used as a suction passage;
the outer nozzle and the outermost nozzle are provided with pluralities of gas blow-off ports and suction ports; and
a mechanism is provided for controlling the flow rate of a gas discharged or sucked through each of the blow-off ports and suction ports by use of an external signal.

6. The powder supply nozzle according to claim 1, wherein:
the powder supply nozzle is provided with the outer nozzle connected to suction equipment and with a tubular outermost nozzle disposed in the periphery of the outer nozzle and connected to the gas supply source;
a blow-off angle of the outermost nozzle is on the outer side relative to a blow-off angle of the outer nozzle; and
the space defined by the outer nozzle and the outermost nozzle is used as a gas supply passage.

7. The powder supply nozzle according to claim 1, wherein:
the powder supply nozzle is provided with the outer nozzle connected to suction equipment and with a tubular outermost nozzle disposed in the periphery of the outer nozzle and connected to the gas supply source;
a blow-off angle of the outermost nozzle is within the range from 0°, exclusive, to 60° inclusive, in a direction for spreading toward the outside of the nozzle relative to the laser optic axis;
the space defined by the outer nozzle and the outermost nozzle is used as a gas supply passage;
the outer nozzle and the outermost nozzle are provided with pluralities of gas blow-off ports and suction ports; and
a mechanism is provided for controlling the flow rate of a gas discharged or sucked through each of the blow-off ports and suction ports by use of an external signal.

8. An overlaying method comprising:
irradiating a workpiece with a laser beam while blowing an inert gas from a laser emission part onto the workpiece so as to supply a laser-irradiated part with a powder together with a carrier gas from a powder supply part comprised of the laser emission part and an inner nozzle provided in the periphery of the laser emission part and thereby to form a clad layer part, wherein:
a guide gas is blown off from an outer nozzle, which is disposed in the periphery of the powder supply part and connected to the gas supply source, at an angle within the range from 0°, exclusive, to 60°, inclusive, in a direction for spreading toward the outer side outside of the nozzle relative to a blow-off direction of the inert gas the laser optic axis.

9. The overlaying method according to claim 8, wherein:
the guide gas is blown off from the outer nozzle at flow velocity of the powder supplied from the powder supply part.

10. The overlaying method according to claim 8, wherein:
the guide gas is blown off from the outer nozzle at a flow velocity greater than the flow velocity of the powder supplied from the powder supply part;
the outer nozzle is provided with a plurality of blow-off ports and with a mechanism for controlling the flow rate of a gas supplied through each of the blow-off ports; and
the guide gas is blown off through each of the gas blow-off ports at an arbitrary flow rate.

11. The overlaying method according to claim 8, wherein:
an outermost nozzle connected to suction equipment is disposed in the periphery of the outer nozzle;
the guide gas is blown off from the outer nozzle at a flow velocity greater than the flow velocity of the powder supplied from the powder supply part; and
the air surrounding the inert gas is sucked through the outermost nozzle.

12. The overlaying method according to claim 8, wherein:
an outermost nozzle connected to suction equipment is disposed in the periphery of the outer nozzle;
the outer nozzle and the outermost nozzle are provided with pluralities of gas blow-off ports and suction ports;
a mechanism is provided for controlling the flow rate of
the guide gas supplied through each of the gas blow-off ports, and
a gas sucked through each of the suction ports; and
the air surrounding the inert gas is sucked through any one of the suction ports of the outer nozzle at any flow rates; and
the guide gas is blown off from any one of the blown-off ports of the outermost nozzle at any flow rates.

13. An overlaying method comprising:
irradiating a workpiece with a laser beam from a laser emission part while blowing an inert gas from a laser emission part onto the workpiece, so as to supply a laser-irradiated part with a powder together with a carrier gas from a powder supply part comprised of the laser emission part and an inner nozzle provided in the periphery of the laser emission part and thereby to form a clad layer part, wherein:
the air surrounding the inert gas is sucked through an outer nozzle disposed in the periphery of the powder supply part and connected to suction equipment;
an outermost nozzle connected to a gas supply source is disposed in the periphery of the outer nozzle; and
a guide gas is blown off from the outermost nozzle at an angle within the range from 0°, exclusive, to 60°, inclusive, in a direction for spreading toward the outside of the nozzle relative to the laser optic axis and at a flow velocity greater than the flow velocity of the powder supplied from the powder supply part.

14. The overlaying method according to claim 13, wherein:
the outer nozzle is provided with a plurality of suction ports;
a mechanism is provided by which to control the flow rate of a gas sucked through each of the suction ports; and
the air surrounding the inert gas is sucked through each of the suction ports at an arbitrary flow rate.

15. The overlaying method according to claim 13, wherein:
an outermost nozzle connected to a gas supply source is disposed in the periphery of the outer nozzle;
the outer nozzle and the outermost nozzle are provided with pluralities of gas blow-off ports and suction ports;
a mechanism is provided for controlling the flow rate of
the guide gas supplied through each of the gas blow-off ports and
the air sucked through each of the suction ports; and
the air surrounding the inert gas is sucked through any one of the suction ports of the outer nozzle at any flow rates; and
the guide gas is blown off from any one of the blown-off ports of the outermost nozzle at any flow rates.

16-21. (canceled)
